(19) United States
(12) Patent Application Publication
(10) Pub. No.: US 2019/0151054 A1
(43) Pub. Date: May 23, 2019

(54) TOOL AND METHOD FOR FORMING A NON-CIRCULAR CAVITY IN BONE TISSUE AND KIT COMPRISING THE TOOL

(71) Applicant: Nobel Biocare Services AG, Kloten (CH)

(72) Inventors: Jorg Weitzel, Rielasingen-Worblingen (DE); Thomas Kaup, Affoltern am Albis (CH); Edmund Burke, Niederbuchsiten (CH); Stefan Holst, Kusnacht (CH)

(21) Appl. No.: 16/091,310

(22) PCT Filed: Apr. 5, 2017
(86) PCT No.: PCT/EP2017/058089

§ 371 Date: Oct. 4, 2018

Related U.S. Application Data
(60) Provisional application No. 62/318,715, filed on Apr. 5, 2016.

(30) Foreign Application Priority Data
Dec. 21, 2016 (EP) 16206013.1

(51) Int. Cl. A61C 8/00; A61C 1/08; A61C 1/00

(52) U.S. Cl. CPC A61C 8/0089; A61C 1/0046; A61C 1/084

(57) ABSTRACT

Method and system for implanting an implant (20, 130) in a bone (12) is provided. An osteotomy (10) having a first transverse cross-sectional shape is formed in a bone (12). An implant (20, 130) having a second transverse cross-sectional shape is inserted into the osteotomy (10), the transverse cross-sectional shape of the implant (20, 130) being different from the transverse cross-sectional shape of the osteotomy (10). The invention further relates to a preparation tool (100) for forming a non-circular cavity (10) in bone tissue (12). The preparation tool (100) comprises a proximal portion (102) and a distal portion (104). The distal portion (104) has a main body (106) and at least one bone removing element (108). At least apart of the at least one bone removing element (108) extends radially outward beyond an outer circumference of the main body (106). Moreover, the invention relates to a kit comprising the preparation tool (100) and an implant (130), such as a dental implant. Also, the invention relates to a kit comprising the preparation tool (100) and a tool guiding means, such as a surgical template.

### BACKGROUND

### Field

The present invention relates generally to a device and method for implanting an implant into bone and, in certain embodiments, to implanting a dental implant into a jaw bone. The invention further relates to a preparation tool for forming a cavity in bone tissue. Moreover, the invention relates to a kit comprising such a preparation tool and an implant, such as a dental implant. Also, the invention relates to a kit comprising such a preparation tool and a tool guiding means, such as a surgical template.

### Description of the Related Art

Implants can be implanted into bone. For example, dental implants can be installed into a patient jawbone to replace a missing tooth. A dental implant can have the form of a threaded screw and can be threaded into a hole (also referred to as an osteotomy) in the patient's bone. Surgical tools can be used to prepare a bone for receiving the implant. Surgical drills can be used to cut bone in order to prepare an osteotomy for an implant. Surgical taps can be used to cut threads in dense bone in order to prepare an osteotomy for receiving an implant. Osteotomes are used to condense soft bone in order to prepare an osteotomy for an implant.

It is known that proper preparation of an implant-receiving hole or cavity can be important to achieving osseointegration and long-term success of a dental implant. Dental implant manufacturers provide guidelines on which combination of tools to use, in which bone quality situations, to achieve the desired insertion torques and/or assumed optimum bone compression around the implant. Guidance on osteotomy preparation can be provided in the form of published “drill protocols.” If the chosen drill protocol is incorrect, this will lead to either too high or too low implant insertion torques, leading to a) too high compression leading to bone resorption, or b) too low compression, leading to large gaps between the implant and the osteotomy wall, which impairs implant stability and bone healing.

The outer surface of the implant is usually provided with a thread, which can be designed as a self-cutting thread or as a not self-cutting thread. The implant can be anchored in a correspondingly prepared implant bed of the jawbone, such as a cavity or an osteotomy. The construction of the thread provided in the external area of the dental implant is usually configured for high primary stability of the arrangement and uniform forwarding of the forces arising under the chewing load of the dental implant into the jawbone.

For this purpose, in particular, for a high primary stability after insertion of the implant into the bone tissue, various approaches for configuring the implant body and the thread are known from the prior art. Various thread geometries and combinations thereof may be provided, for example, by forming different thread types or threads of different thread parameters in different zones of the implant body. From WO 2008/128757 A2, an implant of the above-mentioned type is known, featuring additional helical grooves on the outer surface of the respective thread and/or directly on the implant body between two adjacent threads. In other systems, a compression type thread may be provided, featuring narrow grooves.

High primary stability can also be achieved by undersizing the hole or cavity drilled into the patient's bone at the site provided for the implant, such that, when the implant is screwed in, the core body of the implant together with the threads provided thereon compresses the surrounding bone tissue or material. However, too strong compression may make the blood vessels in the bone tissue collapse, thereby hindering the bone to heal after the insertion of the implant.

Another common objective for the specific design of the implant and the thread provided thereon is the so-called secondary stability or osseointegration, which is the regeneration of bone tissue or material in direct contact with the implant surface.

US 2007/0190491 A1 discloses an implant design with a non-round cross sectional geometry of the implant body. For this design, it has been recognized that most natural teeth are also non-round in cross-section and, therefore, a similar cross-sectional structure of the implant body is assumed to match the natural position of the blood vessels in the bone tissue better, thus promoting good and quick osseointegration.

If an implant with a circular cross-section perpendicular to the axial direction of the implant is inserted into a cavity or osteotomy formed in a patient's bone tissue which also has a circular cross-section, there are uniform high compression stresses in the bone tissue. Such uniform high compression stresses in the bone tissue arise, in particular, for the case of an undersized cavity or osteotomy. These high compression stresses can result in bone resorption and remodelling of the bone around the implant. Since the compression stresses are uniform, the bone resorption and remodelling process is also substantially uniform. Hence, bone can resorb around the entire implant, leading to implant loosening and further subsequent complications.

Moreover, a further problem can arise in narrow and dense bone sites. In this case, it may not be possible to use the largest size drill according to the drill protocol, so that the implant may have to be changed, e.g., replaced by an implant with different dimensions.

Hence, there remains a need for a tool and a method for forming, in a simple and reliable manner, a cavity in bone tissue which allows for the insertion of an implant, in particular, a dental implant, with a high degree of stability and good osseointegration.

### SUMMARY

The systems, methods and devices described herein have innovative aspects, no single one of which is indispensable or solely responsible for their desirable attributes. Without limiting the scope of the claims, some of the advantageous features will now be summarized.

An aspect of the present disclosure is the recognition that if the chosen drill protocol is incorrect, this will lead to either too high or too low implant insertion torques, leading to a) too high compression leading to bone resorption, or b) too low compression, leading to large gaps between the implant and the osteotomy wall, which impairs implant stability and bone healing.

It is an object of the present invention to provide a method and a tool for forming, in a simple and reliable manner, a cavity in bone tissue which allows for the insertion of an implant, in particular, a dental implant, with a high degree of stability and good osseointegration. The invention also offers an assembly and a kit comprising such a tool and an implant, in particular, a dental implant. Moreover, the invention provides a kit comprising such a tool and a tool guiding means, such as a surgical template.

These goals are achieved by a preparation tool with the technical features of claim 1, by a kit with the technical features of claim 17, by a kit with the technical features of claim 20, by a method with the technical features of claim 23, by a method with the technical features of claim 32, by a method with the technical features of claim 40, by an assembly with the technical features of claim 41, by an assembly with the technical features of claim 45 and by an assembly with the technical features of claim 47. Preferred embodiments of the invention follow from the dependent claims.

One aspect of the invention is a method of forming one or more zones of no or lower bone stress and one or more zones of higher bone stress around a dental implant. The method can include forming a hole in a patient's bone, the hole forming a first transverse cross-sectional shape and inserting a dental implant into the hole, the dental implant having a portion positioned within the hole that has a second transverse cross-sectional shape that is different than the first transverse cross-sectional shape such that when the portion of the dental implant is inserted into the hole one or more zones of no or lower bone stress and one more zones of higher bone stress are created around the portion of the dental implant.

Another aspect of the invention is a method of placing a dental implant into a patient comprising forming osteotomy with a non-round transverse cross-section; and inserting an implant with a round transverse cross-section into the osteotomy with the non-round cross-section.

Another aspect of the invention is a method of placing a dental implant into a patient comprising: forming osteotomy with a non-round transverse cross-section; inserting an implant with a non-round transverse cross-section into the osteotomy with the non-round cross-section; and orientating the implant within the osteotomy such that the non-round transverse cross-sections of the osteotomy and the dental implant are not aligned to create one or more zones of no or lower bone stress and one more zones of higher bone stress are created around the portion of the dental implant.

Another aspect of the invention is an assembly comprising an implant and a tool for creating an osteotomy with a non-round transverse cross-section.

Another aspect of the invention is an assembly comprising an implant and a tool for creating an osteotomy having a different transverse cross-section than the implant.

Another aspect of the invention is an assembly comprising implant and tool for creating an osteotomy having a same non-round transverse cross-section as the implant.

According to an aspect of the invention, there is provided a preparation tool for forming a non-circular or non-round cavity, osteotomy or hole in bone tissue, such as the jaw bone of a patient. The preparation tool comprises a proximal portion and a distal portion. The distal portion has a main body and at least one bone removing element. At least a part of the at least one bone removing element extends radially outward beyond an outer circumference of the main body.

The proximal portion of the preparation tool is the portion thereof which is closer to the clinician in use of the preparation tool. The distal portion of the preparation tool is the portion thereof which is closer to the bone tissue, i.e., further away from the clinician, in use of the preparation tool.

The axial direction, i.e., the longitudinal direction, of the preparation tool is the direction from the proximal portion of the preparation tool towards the distal portion of the preparation tool. The radial directions, i.e., the transverse directions, of the preparation tool are perpendicular to the axial direction of the preparation tool. The axial and radial directions of the main body coincide with, i.e., are the same as, the axial and radial directions, respectively, of the preparation tool.

The at least a part of the at least one bone removing element extends radially outward beyond the outer circumference of the main body. Thus, the at least a part of the at least one bone removing element extends outward beyond the outer circumference of the main body in one or more radial or transverse directions of the main body.

The entire at least one bone removing element may extend radially outward beyond the outer circumference of the main body.

The bone removing element is configured to remove bone material, i.e., to take off bone material from the bone tissue, thereby forming the non-circular cavity in the bone tissue, for example, in the jaw bone of a patient. The bone removing element may be configured to remove bone material, for example, by reaming bone tissue, rasping bone tissue, grinding bone tissue or cutting bone tissue.

The at least a part of the at least one bone removing element which extends radially outward beyond the outer circumference of the main body is a bone removing part. The bone removing part is configured to remove bone material. The bone removing part may be configured to remove bone material, for example, by reaming bone tissue, rasping bone tissue, grinding bone tissue or cutting bone tissue.

The preparation tool is for forming a non-circular cavity in bone tissue. The cavity formed by the preparation tool thus has a non-circular cross-section perpendicular to the axial direction of the cavity. The axial direction of the cavity is the direction from a proximal end, e.g., a coronal end, of the cavity towards a distal end, e.g., an apical end, of the cavity.

The distal portion of the preparation tool, having the main body and the at least one bone removing element, may have a non-circular cross-section perpendicular to the axial direction of the preparation tool. The non-circular cross-section of the preparation tool may have substantially the same shape and/or dimensions as the cavity to be formed by the preparation tool. The main body of the distal portion of the preparation tool may have a circular cross-section or a non-circular cross-section perpendicular to the axial direction of the preparation tool, such as an oval, elliptic, trioval or polygonal cross-section or a combination of these cross-sections.

The preparation tool is configured so that the distal portion thereof can be at least partly inserted into a pilot hole in the bone tissue, e.g., in the jaw bone of a patient. The pilot hole may be prepared by drilling a hole in the bone tissue, e.g., following a drill protocol. The pilot hole may have a circular cross-section perpendicular to the axial direction of the pilot hole, i.e., the direction from a proximal end, e.g., a coronal end, of the pilot hole towards a distal end, e.g., an apical end, of the pilot hole. The preparation tool is configured to remove bone material at the inner wall of the pilot hole by means of the at least one bone removing element, thereby forming the non-circular cavity in the bone tissue.

The non-circular cavity formed by the preparation tool allows for the insertion of an implant, in particular, a dental implant, therein. The implant may have a circular cross-section perpendicular to the axial direction of the implant, i.e., the direction from a proximal end, e.g., a coronal end, of the implant towards a distal end, e.g., an apical end, of the implant. The implant may have a non-circular cross-section perpendicular to the axial direction of the implant, e.g., a non-circular cross-section which differs in its shape and/or dimensions from the non-circular cross-section of the cavity.

The term “non-circular” defines a cross-section or cross-sectional shape which deviates from a circular cross-section or cross-sectional shape, such as an oval, elliptic, trioval or polygonal cross-section or cross-sectional shape or a combination of these cross-sections or cross-sectional shapes. An example of a non-circular cross-section is a cross-section having a plurality of radially convex or concave portions which are arranged, e.g., equidistantly arranged, along the circumference of the cross-section.

The preparation tool of the present invention enables, in a simple and reliable manner, the formation of a non-circular cavity in bone tissue, such as the jaw bone of a patient, by means of the at least one bone removing element. The non-circular cavity formed by the preparation tool allows for the insertion of an implant, in particular, a dental implant, therein with a high degree of stability and good osseointegration.

In particular, by forming a non-circular or non-round cavity, osteotomy or hole in the bone tissue using the preparation tool, areas or regions of relatively lower stress, i.e., compression stress, between bone tissue and implant, also referred to as “biologic zones”, and areas or regions of relatively higher stress, i.e., compression stress, between bone tissue and implant, also referred to as “mechanical zones”, are introduced. The bone tissue in the areas or regions of relatively higher stress will resorb and remodel in the same manner as for the case of a circular cavity but the bone tissue will remodel faster in the areas or regions of relatively lower stress. Since the rate of bone resorption and remodelling is different for these two types of areas or regions, the implant will always be in contact with the bone tissue and, therefore, not become loose or unstable. In this way, a high degree of stability and good osseointegration of the implant can be ensured.

Further, the tool offers the possibility of orientating the shape of the non-circular cavity in accordance with the dimensions of the bone tissue in which the cavity is to be formed, thus offering a greater degree of freedom in choosing the dimensions of the cavity and the implant. For example, for the case of a narrow bone ridge, e.g., in the jaw bone of a patient, if a drill protocol, such as a standard drill protocol, is followed for forming a pilot hole in the bone tissue, a larger diameter of the last drill in the protocol can be selected than for the case of a circular cavity.

The at least one bone removing element may extend, in a width direction thereof, along part, e.g., along only a portion, of the outer circumference of the main body in the circumferential direction of the main body. In particular, the at least one bone removing element may extend along 2% or more, 5% or more, 8% or more, 10% or more, 15% or more, 20% or more or 30% or more of the outer circumference of the main body in the circumferential direction of the main body. The width direction of the at least one bone removing element extends along a direction substantially perpendicular to the axial direction of the preparation tool.

The at least a part of the at least one bone removing element which extends radially outward beyond the outer circumference of the main body may extend, in a width direction thereof, along part, e.g., along only a portion, of the outer circumference of the main body in the circumferential direction of the main body. In particular, the at least a part of the at least one bone removing element may extend along 2% or more, 5% or more, 8% or more, 10% or more, 15% or more, 20% or more or 30% or more of the outer circumference of the main body in the circumferential direction of the main body.

The at least one bone removing element may extend, in a length direction thereof, along part, e.g., along only a portion, of the length of the main body in the length direction of the main body. In particular, the at least one bone removing element may extend along 20% or more, 40% or more, 50% or more, 60% or more, 70% or more, 80% or more or 90% or more of the length of the main body in the length direction of the main body. The at least one bone removing element may extend, in the length direction thereof, along the entire length of the main body in the length direction of the main body. The length direction of the at least one bone removing element and the length direction of the main body extend along the axial direction of the preparation tool.

The at least a part of the at least one bone removing element which extends radially outward beyond the outer circumference of the main body may extend, in a length direction thereof, along part, e.g., along only a portion, of the length of the main body in the length direction of the main body. In particular, the at least a part of the at least one bone removing element may extend along 20% or more, 40% or more, 50% or more, 60% or more, 70% or more, 80% or more or 90% or more of the length of the main body in the length direction of the main body. The at least a part of the at least one bone removing element may extend, in the length direction thereof, along the entire length of the main body in the length direction of the main body.

The at least a part of the at least one bone removing element which extends radially outward beyond the outer circumference of the main body may extend, in the length direction thereof, along part, e.g., along only a portion, of the length of the remainder of the at least one bone removing element in the length direction of the remainder of the at least one bone removing element. In particular, the at least a part of the at least one bone removing element may extend along 20% or more, 40% or more, 50% or more, 60% or more, 70% or more, 80% or more or 90% or more of the length of the remainder of the at least one bone removing element in the length direction of the remainder of the at least one bone removing element. The at least a part of the at least one bone removing element may extend, in the length direction thereof, along the entire length of the remainder of the at least one bone removing element in the length direction of the remainder of the at least one bone removing element.

The at least a part of the at least one bone removing element may extend radially outward beyond the outer circumference of the main body by 0.2 to 2.0 mm, 0.4 to 1.8 mm, 0.5 to 1.5 mm or 0.8 to 1.2 mm. The entire at least one bone removing element may extend radially outward beyond the outer circumference of the main body by 0.2 to 2.0 mm, 0.4 to 1.8 mm, 0.5 to 1.5 mm or 0.8 to 1.2 mm.

The main body and the at least one bone removing element may be made of the same material or of different materials.

The main body may be made of, for example, a metal, such as titanium, a titanium alloy or stainless steel, a polymer, a ceramic or a composite material. The main body may be manufactured, for example, by moulding, such as injection moulding, milling, such as CNC milling, etc.

The at least one bone removing element may be made of, for example, a metal, such as titanium, a titanium alloy or stainless steel, a polymer, a ceramic or a composite material. The at least one bone removing element may be manufactured, for example, by moulding, such as injection moulding, milling, such as CNC milling, etc.

The at least a part of the at least one bone removing element may have an abrasive surface. The abrasive surface is configured to remove bone material, i.e., to take off bone material, from the bone tissue, e.g., by reaming the bone tissue, rasping the bone tissue or grinding the bone tissue. The abrasive surface is configured to provide, at least in some areas or regions of the cavity, a rough surface of the inner wall of the cavity, i.e., to roughen the inner cavity wall. The abrasive surface may be a coarse abrasive surface, e.g., an abrasive surface for coarse reaming, coarse rasping or coarse grinding.

By employing the at least one bone removing element having the abrasive surface, enabling the provision of a rough surface of the inner wall of the cavity, osseointegration of the implant in the cavity can be further improved. In particular, in this way, the cells of the bone tissue can be opened, further promoting osseointegration.

Moreover, bone chips removed by the abrasive surface can remain in the cavity where they are not exposed to the outside environment. The presence of these bone chips in the cavity can further contribute to a stable and quick integration of the implant in the bone tissue cavity.

At least a portion of the abrasive surface of the at least a part of the at least one bone removing element may be arranged so as to be substantially parallel to the axial direction of the preparation tool.

The entire at least one bone removing element may have an abrasive surface.

The at least a part of the at least one bone removing element may have a reaming portion, a rasping portion, a grinding portion, a cutting portion or a combination of these portions. For example, the at least a part of the at least one bone removing element may have a blade portion.

The at least one bone removing element may be integrally formed with the main body. Herein, the term “integrally formed” denotes that the at least one bone removing element and the main body are formed in a one-piece configuration.

Forming the at least one bone removing element and the main body in a one-piece configuration allows for the preparation tool to be manufactured in a particularly simple and efficient manner, e.g., by moulding, such as injection moulding, milling, such as CNC milling, etc. The entire preparation tool may be integrally formed, i.e., formed in a one-piece configuration.

The at least one bone removing element may be integrally attached to the main body. Herein, the term “integrally attached” denotes that the at least one bone removing element is attached to the main body in such a manner that the at least one bone removing element cannot be detached or separated from the main body without damaging or destroying the at least one bone removing element and/or the main body.

If the at least one bone removing element is integrally formed with or integrally attached to the main body, a particularly robust and stable configuration of the preparation tool is achieved.

The at least one bone removing element may be movable relative to the main body in the axial direction of the preparation tool. The at least one bone removing element may be movably attached to the main body.

By arranging the at least one bone removing element so as to be movable relative to the main body in the axial direction of the preparation tool, the non-circular cavity can be formed in the bone tissue in a particularly simple and efficient manner, by moving the at least one bone removing element relative to the main body. Moreover, in this way, the non-circular cavity can be formed with a particularly high degree of precision, thus achieving a further improvement in implant stability and osseointegration. The main body may be kept substantially stationary relative to the bone tissue during the relative movement of the at least one bone removing element and the main body.

The at least one bone removing element may be movable relative to the main body in the axial direction of the preparation tool over a movement length which extends along 1% or more, 5% or more, 10% or more, 20% or more, 30% or more, or 40% or more of the length of the main body in the length direction of the main body. For example, in one embodiment the movement of said bone removing element can have a movement length of plus minus 0.5 mm.

The at least one bone removing element may be movable relative to the main body in a rotational direction around the axial direction of the preparation tool. Hence, the at least one bone removing element may be movable relative to the main body in the circumferential direction of the main body.

The at least one bone removing element may be movable relative to the main body in the axial direction of the preparation tool and in the rotational direction around the axial direction of the preparation tool, e.g., enabling a helical movement path of the at least one bone removing element relative to the main body.

The preparation tool may further comprise a shaft extending in the axial direction of the preparation tool. The shaft may be rotatable relative to the main body. The shaft may be rotatable relative to the main body in a rotational direction around the axial direction of the preparation tool. Hence, the shaft may be rotatable relative to the main body in the circumferential direction of the main body. The shaft and the main body may be arranged so as to be coaxial with each other, i.e., so that the axial direction of the shaft is the same as the axial direction of the main body. The shaft may be rotatable relative to the main body around this axial direction. The shaft may be rotatable relative to the main body and the at least one bone removing element. The shaft may be rotatable relative to the main body and the at least one bone removing element in the rotational direction around the axial direction of the preparation tool.

The shaft may be connected to the at least one bone removing element so that rotation of the shaft relative to the main body causes the at least one bone removing element to move relative to the main body in the axial direction of the preparation tool.

In this way, a movement of the at least one bone removing element relative to the main body in the axial direction of the preparation tool can be effected in a particularly simple and efficient manner. For example, for this purpose, the shaft can be rotated relative to the main body, e.g., manually or by using a rotation motor or the like.

The shaft may be connected to the at least one bone removing element so that continuous rotation of the shaft relative to the main body, i.e., continuous rotation in the same rotational direction, causes the at least one bone removing element to reciprocate relative to the main body in the axial direction of the preparation tool.

Such a reciprocating movement of the at least one bone removing element relative to the main body in the axial direction of the preparation tool allows for the non-circular cavity to be formed in a particularly simple and reliable manner. Further, this reciprocating movement can be effected in a simple way, by continuously rotating the shaft relative to the main body, e.g., manually or by using a rotation motor or the like.

The shaft may have at least one recess extending in the radial direction or directions of the shaft and in the circumferential direction of the shaft. The at least one recess may extend along part of the circumference of the shaft. The at least one recess may extend along the entire circumference of the shaft. The at least one bone removing element may have at least one protrusion extending in the radial direction of the shaft. The at least one protrusion may be at least partly received within the at least one recess, in particular, so that rotation of the shaft relative to the main body causes the at least one bone removing element to move relative to the main body at least in the axial direction of the preparation tool. The at least one protrusion may be fully received within the at least one recess.

By providing the shaft with at least one such recess and the at least one bone removing element with at least one such protrusion, a reliable and simple connection between the shaft and the at least one bone removing element is established.

The at least one recess may extend along part of the circumference of the shaft or along the entire circumference of the shaft in an undulating, wavelike or sinusoidal manner. In this case, the direction of amplitude of the undulating, wavelike or sinusoidal shape of the at least one recess is parallel to the axial direction of the shaft. In this way, a simple and reliable connection between the shaft and the at least one bone removing element is provided which enables a reciprocating movement of the at least one bone removing element relative to the main body in the axial direction of the preparation tool upon continuous rotation of the shaft relative to the main body.

The shaft may have at least one protrusion extending in the radial direction or directions of the shaft and in the circumferential direction of the shaft. The at least one protrusion may extend along part of the circumference of the shaft. The at least one protrusion may extend along the entire circumference of the shaft. The at least one bone removing element may have at least one recess extending in the radial direction of the shaft. The at least one protrusion may be at least partly received within the at least one recess, in particular, so that rotation of the shaft relative to the main body causes the at least one bone removing element to move relative to the main body at least in the axial direction of the preparation tool. The at least one protrusion may be fully received within the at least one recess.

The at least one protrusion may extend along part of the circumference of the shaft or along the entire circumference of the shaft in an undulating, wavelike or sinusoidal manner. In this case, the direction of amplitude of the undulating, wavelike or sinusoidal shape of the at least one protrusion is parallel to the axial direction of the shaft. Also in this way, a simple and reliable connection between the shaft and the at least one bone removing element is provided which enables a reciprocating movement of the at least one bone removing element relative to the main body in the axial direction of the preparation tool upon continuous rotation of the shaft relative to the main body.

The shaft may extend from the proximal portion to the distal portion of the preparation tool. The shaft may extend substantially along the entire length of the preparation tool, e.g., a remainder of the preparation tool, in the axial direction of the preparation tool. The shaft may extend only along part of the length of the preparation tool, e.g., a remainder of the preparation tool, in the axial direction of the preparation tool. For example, the shaft may extend along 30% or more, 50% or more, 70% or more, 80% or more, or 90% or more of the length of the preparation tool, e.g., a remainder of the preparation tool, in the axial direction of the preparation tool.

A distal part or a distal end of the shaft may be at least partly housed or received within the main body. In this way, a particularly compact and robust configuration of the preparation tool can be achieved.

A proximal part or a proximal end of the shaft may be exposed to the outside of the preparation tool. In this way, the shaft can be manipulated in a particularly simple and efficient manner, e.g., manually or by using a motor, such as a rotation motor or the like. For example, the shaft can be rotated relative to the main body, e.g., by driving the shaft by hand or with a motor, so as to cause the at least one bone removing element to move relative to the main body in the axial direction of the preparation tool.

The main body may have at least one fixation element for rotational fixation of the main body in a pilot hole formed in bone tissue so as to prevent rotation of the main body relative to the bone tissue in the circumferential direction of the main body.

By providing such an at least one fixation element, the main body can be kept substantially stationary relative to the bone tissue in a particularly reliable manner, in particular, in the circumferential direction of the main body. The non-circular cavity can be formed by moving the at least one bone removing element relative to the main body. In this way, the degree of precision with which the cavity can be formed is further enhanced, thus achieving particularly good implant stability and osseointegration.

The at least one fixation element may protrude from a remainder of the main body in the radial direction or directions of the main body, i.e., so as to extend radially outward beyond the outer circumference of the remainder of the main body. The at least one fixation element may extend radially outward beyond the outer circumference of the remainder of the main body by 0.2 to 2.0 mm, 0.4 to 1.8 mm, 0.5 to 1.5 mm or 0.8 to 1.2 mm.

The at least one fixation element may extend along the axial direction of the main body. The at least one fixation element may extend along the entire length of the main body, e.g., a remainder of the main body, in the axial direction of the main body. The at least one fixation element may extend only along part of the length of the main body, e.g., a remainder of the main body, in the axial direction of the main body. For example, the at least one fixation element may extend along 30% or more, 50% or more, 70% or more, 80% or more, or 90% or more of the length of the main body, e.g., a remainder of the main body, in the axial direction of the main body.

For example, the at least one fixation element may be a ridge, a rib, a fin, a spike or the like.

The at least one fixation element may be integrally formed with or integrally attached to the remainder of the main body. In this way, a particularly robust and stable configuration of the preparation tool can be achieved.

The main body may have a plurality of fixation elements for rotational fixation of the main body in the pilot hole, e.g., two or more, three or more, four or more, or five or more fixation elements. The fixation elements may be arranged so as to be spaced apart from each other, in particular, equidistantly spaced apart from each other, in the circumferential direction of the main body.

The preparation tool may further comprise an intermediate portion, wherein the intermediate portion is arranged between the proximal portion and the distal portion. At least a part of the intermediate portion may have a non-circular cross-section perpendicular to the axial direction of the preparation tool. The intermediate portion may be fixedly attached to or fixedly connected with the distal portion, in particular, the main body, and/or the proximal portion. The intermediate portion may be integrally formed with or integrally attached to the distal portion, in particular, the main body, and/or the proximal portion.

The intermediate portion of the preparation tool, at least a part of which has a non-circular cross-section perpendicular to the axial direction of the preparation tool, allows for a rotation of the main body relative to the bone tissue in the circumferential direction of the main body to be reliably prevented.

In particular, the preparation tool may be used together with a tool guiding means, such as a surgical template, e.g., a surgical template for guided surgery. The tool guiding means may have a receiving portion into which the preparation tool can be at least partly inserted. The receiving portion may be configured to prevent rotation of the main body of the preparation tool relative to the tool guiding means by cooperation with the at least a part of the intermediate portion which has a non-circular cross-section perpendicular to the axial direction of the preparation tool. For example, the receiving portion may have a recess for receiving therein the at least a part of the intermediate portion, wherein the recess has a non-circular cross-section which is substantially identical to that of the at least a part of the intermediate portion. In this way, the at least a part of the intermediate portion and the recess of the tool guiding means together provide an anti-rotational feature, preventing rotation of the main body relative to the bone tissue in the circumferential direction of the main body. Alternatively or additionally, such anti-rotational features may also be provided by other parts or portions of the preparation tool, e.g., by other parts or portions which are arranged more proximally than the intermediate portion and/or by other parts or portions which are arranged more distally than the intermediate portion.

The shaft may be rotatable relative to the intermediate portion. The shaft may be rotatable relative to the intermediate portion in a rotational direction around the axial direction of the preparation tool. Hence, the shaft may be rotatable relative to the intermediate portion in the circumferential direction of the intermediate portion. The shaft and the intermediate portion may be arranged so as to be coaxial with each other, i.e., so that the axial direction of the shaft is the same as the axial direction of the intermediate portion. The shaft may be rotatable relative to the intermediate portion around this axial direction.

A distal part of the at least one bone removing element may have a radial extension in one or more directions perpendicular to the axial direction of the preparation tool, which radial extension decreases in the direction from the proximal portion towards the distal portion.

By choosing a distal part of the at least one bone removing element with the configuration detailed above, it can be particularly reliably ensured that the distal portion of the preparation tool can be, at least partly, inserted into a pilot hole in the bone tissue, e.g., in the jaw bone of a patient, in a precise, efficient and easy manner.

The at least one bone removing element may have one or more tapered or chamfered portions in which the radial extension of the at least one bone removing element in one or more directions perpendicular to the axial direction of the preparation tool decreases in the direction from the proximal portion towards the distal portion of the tool. A plurality of such tapered or chamfered portions, for example, two or more, three or more, four or more, or five or more tapered or chamfered portions, may be arranged adjacent to each other along the axial direction of the preparation tool so that the degree of taper or chamfer, i.e., the slope, of the tapered or chamfered portions increases in the direction from the proximal portion towards the distal portion of the tool.

The at least one bone removing element may have a plurality of portions arranged adjacent to each other along the axial direction of the preparation tool wherein, in each of these portions, the radial extension of the at least one bone removing element in the directions perpendicular to the axial direction of the preparation tool remains constant in the direction from the proximal portion towards the distal portion of the tool, and the portions are arranged such that the constant radial extensions of the portions become successively smaller in the direction from the proximal portion towards the distal portion of the tool. In this case, steps are formed between adjacent ones of these portions. The at least one bone removing element may have two or more, three or more, four or more, or five or more of such portions arranged adjacent to each other.

Alternatively, the at least one bone removing element may be configured so that the radial extension thereof in the directions perpendicular to the axial direction of the preparation tool remains constant in the direction from the proximal portion towards the distal portion of the tool.

The main body or a part of the main body, e.g., a distal part of the main body, may have a radial extension in the directions perpendicular to the axial direction of the preparation tool, which radial extension decreases in the direction from the proximal portion towards the distal portion. In this way, insertion of the distal portion of the preparation tool into a pilot hole in the bone tissue, e.g., in the jaw bone of a patient, can be further facilitated.

The main body or a part of the main body, e.g., a distal part of the main body, may have one or more tapered or chamfered portions in which the radial extension of the main body or the part of the main body, e.g., the distal part of the main body, in the directions perpendicular to the axial direction of the preparation tool decreases in the direction from the proximal portion towards the distal portion of the tool. A plurality of such tapered or chamfered portions, for example, two or more, three or more, four or more, or five or more tapered or chamfered portions, may be arranged adjacent to each other along the axial direction of the preparation tool so that the degree of taper or chamfer, i.e., the slope, of the tapered or chamfered portions increases in the direction from the proximal portion towards the distal portion.

The main body or a part of the main body, e.g., a distal part of the main body, may have a plurality of portions arranged adjacent to each other along the axial direction of the preparation tool wherein, in each of these portions, the radial extension of the main body or the part of the main body, e.g., the distal part of the main body, in the directions perpendicular to the axial direction of the preparation tool remains constant in the direction from the proximal portion towards the distal portion of the tool, and the portions are arranged such that the constant radial extensions of the portions become successively smaller in the direction from the proximal portion towards the distal portion of the tool. In this case, steps are formed between adjacent ones of these portions. The main body or the part of the main body, e.g., the distal part of the main body, may have two or more, three or more, four or more, or five or more of such portions arranged adjacent to each other.

Alternatively, the main body or the part of the main body, e.g., the distal part of the main body, may be configured so that the radial extension thereof in the directions perpendicular to the axial direction of the preparation tool remains constant in the direction from the proximal portion towards the distal portion of the tool.

The distal portion of the preparation tool may have a plurality of bone removing elements. For example, the distal portion may have 2 to 12, 3 to 10, 4 to 9 or 5 to 8 bone removing elements.

By providing a plurality of bone removing elements, the forces acting on the bone tissue when forming the non-circular cavity therein can be applied more uniformly.

The bone removing elements may be arranged so as to be spaced apart from each other in the circumferential direction of the main body. In particular, the bone removing elements may be arranged so as to be equidistantly spaced apart from each other in the circumferential direction of the main body. Alternatively, the bone removing elements may be arranged so as to be spaced apart from each other in the circumferential direction of the main body at different intervals.

The preparation tool may be configured so that, in operation of the preparation tool, the movements of the bone removing elements relative to the main body in the axial direction of the preparation tool are out of phase with each other. In this way, the forces acting on the bone tissue when forming the non-circular cavity therein can be applied in a particularly uniform manner, achieving a balance between the forces acting on different parts of the bone tissue.

For example, such out of phase movements of the bone removing elements relative to the main body in the axial direction of the preparation tool can be achieved by providing a shaft with at least one recess or protrusion extending along part of the circumference of the shaft or along the entire circumference of the shaft in an undulating, wavelike or sinusoidal manner, as has been detailed above.

Alternatively, the preparation tool may be configured so that, in operation of the preparation tool, the movements of the bone removing elements relative to the main body in the axial direction of the preparation tool are in phase with each other.

According to an aspect of the invention, there is provided a kit comprising the preparation tool according to the invention and an implant, such as a dental implant.

The implant, in particular, the dental implant, may have a circular cross-section perpendicular to the axial direction of the implant. The axial direction of the implant is the direction from a proximal end, e.g., a coronal end, of the implant towards a distal end, e.g., an apical end, of the implant.

By using the preparation tool of the invention together with an implant having a circular cross-section, i.e., by forming a non-circular cavity in bone tissue by means of the tool and inserting the implant therein, a particularly high degree of stability and improved osseointegration of the implant can be ensured.

The distal portion of the preparation tool may have a radial extension in one or more directions perpendicular to the axial direction of the preparation tool which is larger than a radial extension of the implant in the directions perpendicular to the axial direction of the implant. In this way, it can be reliably ensured that, when inserting the implant into the non-circular cavity formed by means of the preparation tool, areas or regions of relatively lower stress, i.e., compression stress, between bone tissue and implant, also referred to as “biologic zones”, are introduced. The bone tissue will remodel faster in these areas or regions of relatively lower stress, as has been detailed above.

The distal portion of the preparation tool may have a radial extension in one or more directions perpendicular to the axial direction of the preparation tool which is smaller than a radial extension of the implant in the directions perpendicular to the axial direction of the implant. In this way, it can be reliably ensured that, when inserting the implant into the non-circular cavity formed by means of the preparation tool, areas or regions of relatively higher stress, i.e., compression stress, between bone tissue and implant, also referred to as “mechanical zones”, are introduced.

The distal portion of the preparation tool may have a radial extension in one or more directions perpendicular to the axial direction of the preparation tool which is larger than a radial extension of the implant in the directions perpendicular to the axial direction of the implant and a radial extension in one or more directions perpendicular to the axial direction of the preparation tool which is smaller than the radial extension of the implant in the directions perpendicular to the axial direction of the implant. In this way, it can be ensured that both “biologic zones” and “mechanical zones” are introduced when inserting the implant into the non-circular cavity. Since the rate of bone resorption and remodelling is different for these two types of zones, the implant will always be in contact with the bone tissue and, therefore, not become loose or unstable. Therefore, a particularly high degree of stability and good osseointegration of the implant can be ensured.

According to an aspect of the invention, there is provided a kit comprising the preparation tool according to the present invention and a tool guiding means, such as a surgical template, e.g., a surgical template for guided surgery.

The tool guiding means may have a receiving portion into which the preparation tool can be at least partly inserted. The receiving portion may be configured to prevent rotation of the main body of the preparation tool relative to the tool guiding means.

The preparation tool may comprise an intermediate portion arranged between the proximal portion and the distal portion, wherein at least a part of the intermediate portion has a non-circular cross-section perpendicular to the axial direction of the preparation tool. The receiving portion may be configured to prevent rotation of the main body of the preparation tool relative to the tool guiding means by cooperation with the at least a part of the intermediate portion.

For example, the receiving portion may have a recess for receiving therein the at least a part of the intermediate portion, wherein the recess has a non-circular cross-section which is substantially identical to that of the at least a part of the intermediate portion. In this way, the at least a part of the intermediate portion and the recess of the tool guiding means together provide an anti-rotational feature, preventing rotation of the main body relative to the bone tissue in the circumferential direction of the main body.

According to an aspect of the invention, there is provided a kit comprising the preparation tool according to the present invention, an implant, such as a dental implant, and a tool guiding means, such as a surgical template.

According to an aspect of the invention, there is provided a kit comprising the preparation tool according to the present invention and a drill, e.g., a dental drill, or a set of drills, e.g., a set of dental drills.

The distal portion of the preparation tool may have a radial extension in one, plural or all directions perpendicular to the axial direction of the preparation tool which is larger than a radial extension of the drill in the directions perpendicular to the axial direction of the drill. The axial direction of the drill is the direction from a proximal end of the drill towards a distal end of the drill. In this way, it can be ensured that at least a part of the distal portion of the preparation tool can be held by press-fit in the hole, such as a pilot hole, drilled by the drill. Hence, a rotation of the main body relative to the bone tissue in the circumferential direction of the main body can be reliably suppressed.

The distal portion of the preparation tool may have a distal end with a radial extension in the directions perpendicular to the axial direction of the preparation tool which is smaller than a radial extension of the drill in the directions perpendicular to the axial direction of the drill. The remainder of the distal portion of the preparation tool may have a radial extension in one, plural or all directions perpendicular to the axial direction of the preparation tool which is larger than a radial extension of the drill in the directions perpendicular to the axial direction of the drill. In this way, insertion of at least a part of the distal portion into the hole drilled by the drill can be facilitated while, at the same time, achieving a press-fit between distal portion and hole.

The radial extensions of the drills of the set of drills in the directions perpendicular to the axial directions of the drills, i.e., the drill diameters, may be different from each other. Thus, the set of drills can be used to drill holes or cavities in bone tissue, wherein the hole or cavity diameter is increased with every drilling step using the drill which is next in size, for example, following a drill protocol. The drill of the set of drills having the largest diameter may be used for forming a pilot hole in the bone tissue for the preparation tool.

The distal portion of the preparation tool may have a radial extension in one, plural or all directions perpendicular to the axial direction of the preparation tool which is larger than a radial extension, in the directions perpendicular to the axial direction of the drill, of the drill of the set of drills which has the largest diameter.

The distal portion of the preparation tool may have a distal end with a radial extension in the directions perpendicular to the axial direction of the preparation tool which is smaller than a radial extension, in the directions perpendicular to the axial direction of the drill, of the drill of the set of drills which has the largest diameter. The remainder of the distal portion of the preparation tool may have a radial extension in one, plural or all directions perpendicular to the axial direction of the preparation tool which is larger than a radial extension, in the directions perpendicular to the axial direction of the drill, of the drill of the set of drills which has the largest diameter.

According to an aspect of the invention, there is provided a kit comprising the preparation tool according to the present invention, an implant, such as a dental implant, and a drill, e.g., a dental drill, or a set of drills, e.g., a set of dental drills.

According to an aspect of the invention, there is provided a kit comprising the preparation tool according to the present invention, a tool guiding means, such as a surgical template, and a drill, e.g., a dental drill, or a set of drills, e.g., a set of dental drills.

According to an aspect of the invention, there is provided a kit comprising the preparation tool according to the present invention, an implant, such as a dental implant, a tool guiding means, such as a surgical template, and a drill, e.g., a dental drill, or a set of drills, e.g., a set of dental drills.

According to an aspect of the invention, there is provided a method of forming a non-circular cavity in bone tissue using the preparation tool of the present invention. The method may be performed using one of the kits of the present invention.

The method of forming a non-circular cavity in bone tissue using the preparation tool of the present invention may comprise the step of forming a hole, such as a pilot hole, in the bone tissue, e.g., in the jaw bone of a patient. The hole may be formed in the bone tissue by drilling, e.g., following a drill protocol, for example, by using the drill or the set of drills of one of the kits of the invention.

The hole may have a circular cross-section perpendicular to the axial direction of the hole, i.e., the direction from a proximal end, e.g., a coronal end, of the hole towards a distal end, e.g., an apical end, of the hole.

The distal portion of the preparation tool may have a radial extension in one, plural or all directions perpendicular to the axial direction of the preparation tool which is larger than a radial extension of the hole in the directions perpendicular to the axial direction of the hole. In this way, it can be ensured that at least a part of the distal portion of the preparation tool can be held by press-fit in the hole, such as a pilot hole.

The distal portion of the preparation tool may have a distal end with a radial extension in the directions perpendicular to the axial direction of the preparation tool which is smaller than a radial extension of the hole in the directions perpendicular to the axial direction of the hole. The remainder of the distal portion of the preparation tool may have a radial extension in one, plural or all directions perpendicular to the axial direction of the preparation tool which is larger than a radial extension of the hole in the directions perpendicular to the axial direction of the hole. In this way, insertion of at least a part of the distal portion into the hole can be facilitated while, at the same time, achieving a press-fit between distal portion and hole.

The method of forming a non-circular cavity in bone tissue may further comprise the step of at least partly inserting the distal portion of the preparation tool into the hole in the bone tissue.

Rotation of the main body relative to the bone tissue in the circumferential direction of the main body can be prevented, for example, in the manner detailed above, e.g., by achieving a press-fit between the at least a part of the distal portion and the hole or by providing the main body with one or more fixation elements for rotational fixation of the main body in the hole.

The method of forming a non-circular cavity in bone tissue may further comprise the step of removing bone material at the inner wall of the hole by means of the at least one bone removing element, thereby forming the non-circular cavity. This bone removal process may be performed in the manner detailed above, e.g., by moving the at least one bone removing element relative to the main body. The main body may be kept substantially stationary relative to the bone tissue during the relative movement of the at least one bone removing element and the main body.

### BRIEF DESCRIPTION OF THE DRAWINGS

Throughout the drawings, reference numbers can be reused to indicate general correspondence between reference elements. The drawings are provided to illustrate example embodiments described herein and are not intended to limit the scope of the disclosure.

FIG. 1A shows a top view of an embodiment of an osteotomy.

FIG. 1B shows a top view of the osteotomy of FIG. 1A.

FIG. 1C shows a top view of the osteotomy of FIG. 1A.

FIG. 2A shows a top view of an embodiment of a non-round osteotomy.

FIG. 2B shows a top view of a round implant inserted into the non-round osteotomy of FIG. 2A.

FIG. 3A shows a top view of an embodiment of a non-round osteotomy.

FIG. 3B shows a top view of a round implant inserted into the non-round osteotomy of FIG. 3A.

FIG. 4A shows a top view of an embodiment of a non-round osteotomy.

FIG. 4B shows a top view of a round implant inserted into the non-round osteotomy of FIG. 4A.

FIG. 5 shows a top view of an embodiment of a non-round osteotomy.

FIG. 6A shows a top view of an embodiment of a non-round osteotomy.

FIG. 6B shows a top view of a round implant inserted into the non-round osteotomy of FIG. 7A.

FIG. 7A shows a top view of an embodiment of a non-round osteotomy.

FIG. 7B shows a top view of a round implant inserted into the non-round osteotomy of FIG. 6A.

FIG. 8A shows a top view of an embodiment of a non-round osteotomy.

FIG. 8B shows a top view of a round implant inserted into the non-round osteotomy of FIG. 8A.

FIG. 9 shows a preparation tool according to an embodiment of the present invention, wherein FIG. 9(a) is a perspective view of the entire preparation tool, and FIG. 9(b) is a perspective view of the preparation tool with some of the outer parts thereof removed.

FIG. 10 shows the preparation tool according to the embodiment of the present invention, wherein FIG. 10(a) is a perspective view of distal and intermediate portions of the preparation tool, and FIG. 10(b) is a side view of the distal portion of the preparation tool.

FIG. 11 shows the preparation tool according to the embodiment of the present invention, wherein FIG. 11(a) is a perspective view of bone removing elements and a portion of a shaft of the preparation tool, FIG. 11(b) is a cross-sectional view of the distal and intermediate portions of the preparation tool taken along a plane parallel to the axial direction of the preparation tool, and FIG. 11(c) is a cross-sectional view of the preparation tool along line C-C in FIG. 11(b).

FIG. 12 shows components of the preparation tool according to the embodiment of the present invention, wherein FIG. 12(a) is a perspective view of the shaft of the preparation tool, and FIG. 12(b) is a perspective view of a bone removing element of the preparation tool.

FIG. 13 shows the preparation tool according to the embodiment of the present invention and an implant, wherein FIG. 13(a) is a perspective overlay view of the entire preparation tool and the implant, and FIG. 13(b) is a perspective overlay view of the distal portion of the preparation tool.

### DETAILED DESCRIPTION OF PREFERRED EMBODIMENTS

Embodiments of systems, components and methods of assembly and manufacture will now be described with reference to the accompanying figures, wherein like numerals refer to like or similar elements throughout. Although several embodiments, examples and illustrations are disclosed below, it will be understood by those of ordinary skill in the art that the inventions described herein extends beyond the specifically disclosed embodiments, examples and illustrations, and can include other uses of the inventions and obvious modifications and equivalents thereof. The terminology used in the description presented herein is not intended to be interpreted in any limited or restrictive manner simply because it is being used in conjunction with a detailed description of certain specific embodiments of the inventions. In addition, embodiments of the inventions can comprise several novel features and no single feature is solely responsible for its desirable attributes or is essential to practicing the inventions herein described.

Certain terminology may be used in the following description for the purpose of reference only, and thus are not intended to be limiting. For example, terms such as “above” and “below” refer to directions in the drawings to which reference is made. Terms such as “front,” “back,” “left,” “right,” “rear,” and “side” describe the orientation and/or location of portions of the components or elements within a consistent but arbitrary frame of reference which is made clear by reference to the text and the associated drawings describing the components or elements under discussion. Moreover, terms such as “first,” “second,” “third,” and so on may be used to describe separate components. Such terminology may include the words specifically mentioned above, derivatives thereof, and words of similar import.

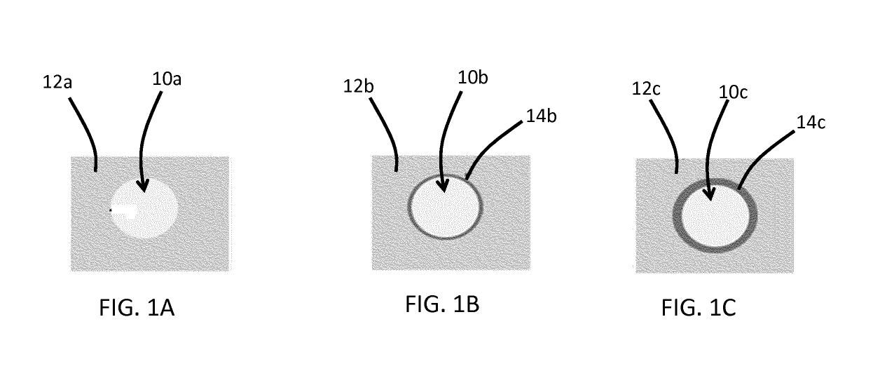

FIG. 1A depicts an osteotomy 10a and a portion of bone 12a that surrounds the osteotomy 10a. When an implant (shown in FIG. 1B) is installed into the osteotomy 10, the bone 12 surrounding the osteotomy may be subjected to high stress, high strain, high insertion torques and/or high temperatures that may result in localized bone cell damage and/or bone cell death in the vicinity of the osteotomy. The depth of the bone cell damage can be referred to as a “zone of death” 14 (“ZOD”). The size and shape of the ZOD 14 will depend on the shape of the osteotomy 10 and the shape of the implant that is installed into the osteotomy 10. The osteotomy 10 shown in FIGS. 1A-C has a generally circular or round transverse cross-sectional shape. If an implant with a circular transverse cross-sectional shape is installed into the osteotomy 10, the ZOD 14 will have a generally circular shape and be concentric with the osteotomy 10. FIG. 1B shows a ZOD 14b that is thinner than the ZOD 14c shown in FIG. 1C. Such an instance could arise if a circular implant were implanted into both osteotomies, with the implant that is installed into the osteotomy of FIG. 1B having a smaller diameter than the implant that is installed into the osteotomy of FIG. 1C.

It is believed that the ZOD 14 is largely a function of stress-strain and heat. The bone cell damage or death in the ZOD 14 can lead to bone resorption, resulting in implant loosening and then bone remodeling. Low stress can be associated with good bone healing response, while high stress can be associated with bad healing response. The smaller the ZOD 14 the better.

When a round dental implant is inserted in a round osteotomy, particularly if the osteotomy is undersized, there can be uniform high compression stresses in the bone. These high stresses can lead to bone resorption and remodeling around the implant. Because the stress mode is uniform, the resorption and remodeling process can also be substantially uniform. Hence, bone can resorb around the whole implant at the same time, which can result in implant loosening and further subsequent complications.

According to certain embodiments, the methods and devices disclosed herein allow the ZOD 14 to be reduced, managed or tailored to improve implant healing. In certain embodiments of the present disclosure, an implant has a different transverse cross-sectional shape than the osteotomy into which the implant is inserted. In certain embodiments, it would be beneficial to create a non-round osteotomy with a non-round transverse cross-sectional shape. A non-round osteotomy can provide areas of relatively higher bone compression or stress that provide primary implant stability following implantation. The non-round osteotomy can also provide areas of relatively lower or no bone compression or stress that achieve good blood supply to the region and can promote rapid osseointegration and development of secondary stability.

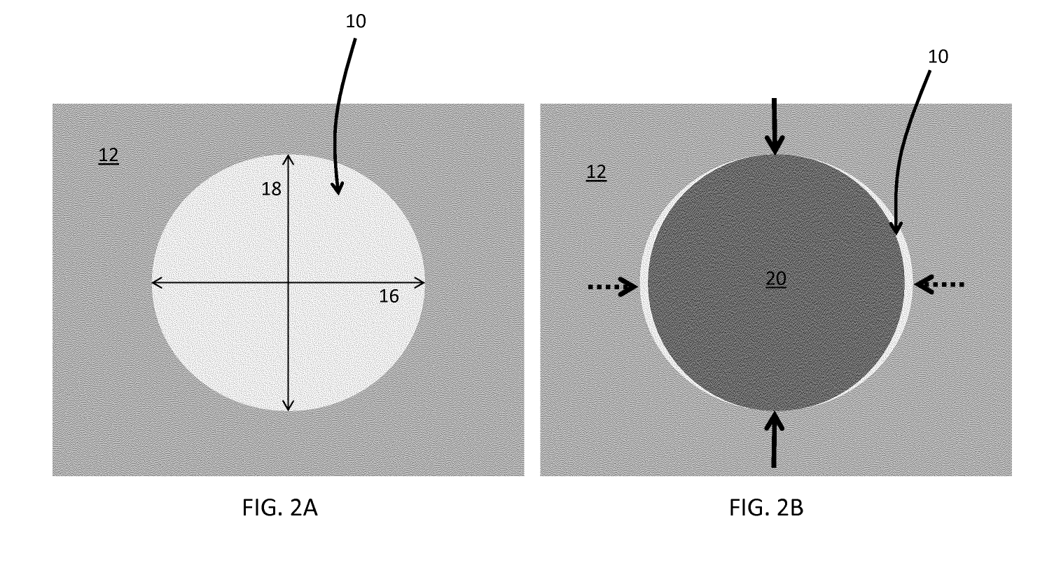

FIG. 2A depicts an embodiment of a non-round osteotomy 10 with a non-round transverse cross-sectional shape. The illustrated osteotomy is oval, having a first width 16 that is slightly larger than a second width 18. The osteotomy 10 can be formed by placing two holes adjacent but off center to each other. In certain embodiments, the holes can be formed by a tool that can create a non-round hole such as a milling instrument. FIG. 2B shows a round implant 20 that has been installed in the non-round osteotomy 10. As shown in FIG. 2B, the bone 12 in the vicinity of the second width 18 of the osteotomy 10 will be subjected to higher compression forces (solid arrows) while the bone in the vicinity of the first width 16 will be subjected to lower compression forces (dashed arrows). The bone 12 in the areas of higher compression forces or stress can stabilize the implant 20 (e.g., primary stability or mechanical stability) while the bone 12 in the areas of lower compression forces or stress can osseointegrate with the implant 20 (secondary stability). In this way, the higher compression zone can be referred to as a “mechanical zone” and the lower compression zone can be referred to as a “biologic zone”.

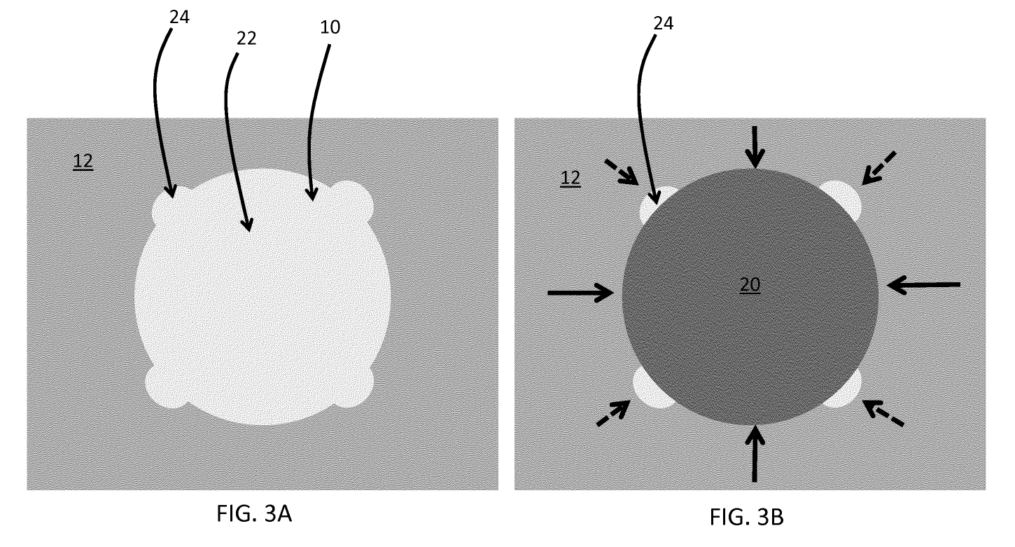

FIG. 3A depicts another embodiment of a non-round osteotomy 10 with a non-round transverse cross-sectional shape. The illustrated osteotomy 10 has round or non-round central portion 22 with one or more round or non-round minor or smaller diameter portions 24 distributed around the perimeter of the central portion 22. As shown in FIG. 3B, lower compression forces (dashed arrows) can be associated with the minor portions 24 of the osteotomy 10 while higher compression forces (solid arrows) can be associated with the regions of the central portion 22 that are interposed between the minor portions 24. The illustrated osteotomy can be created with a drill template. In certain embodiments, the central potion 22 can be formed first and then the minor portions 24 can be formed afterwards. In certain embodiments, the central portion 22 can be drilled first using a large drill, then the minor portions 24 can be drilled with a smaller drill. In some variants, the central portion 22 and minor portions 24 can be drilled using normal twist drills. In some embodiments, the central portion 22 and minor portions 24 are round, and combining the round central portion 22 and the round minor portions 24 produces an osteotomy 10 that is non-round. In certain embodiments, the central portion 22 and/or the minor portions can be non-round and combining the round central portion 22 and the round minor portions 24 produces an osteotomy 10 that is non-round. In certain embodiments, the implant 20 positioned within the osteotomy 10 can have a diameter that is close to or smaller than the diameter of the central portion 22.

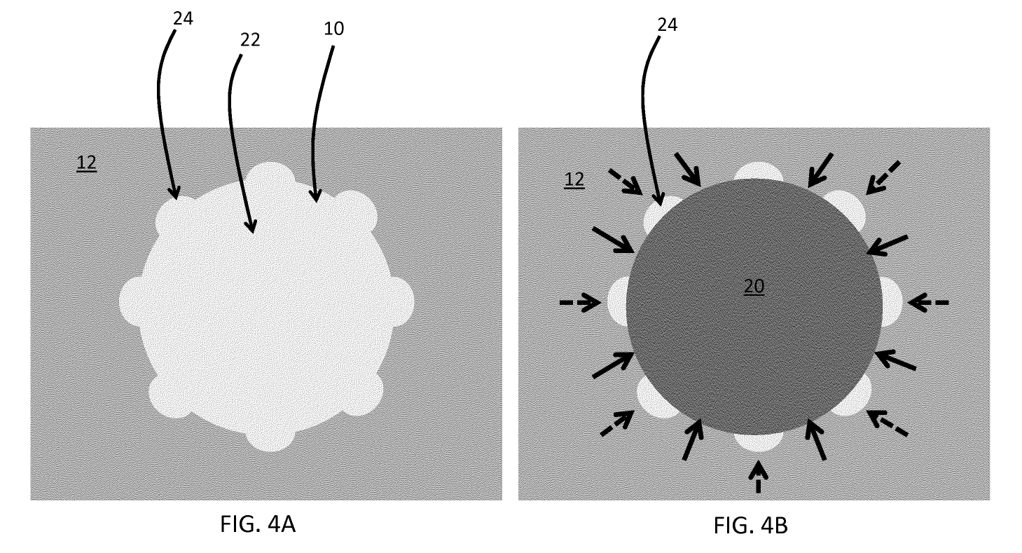

FIG. 4A depicts another embodiment of a non-round osteotomy 10 that is similar to the embodiment shown in FIG. 3A except that the embodiment in FIG. 4A includes additional minor portions 24. The minor portions 24 can be substantially equal to one another in size and shape and distributed substantially uniformly circumferentially around the central portion 22. However, in certain embodiments, the minor portions 24 are not substantially equal to one another in size and/or in shape and/or are unevenly distributed circumferentially around the perimeter of the central portion 22. In certain embodiments, the implant 20 positioned within the osteotomy 10 can have a diameter that is close to or smaller than the diameter of the central portion 22.

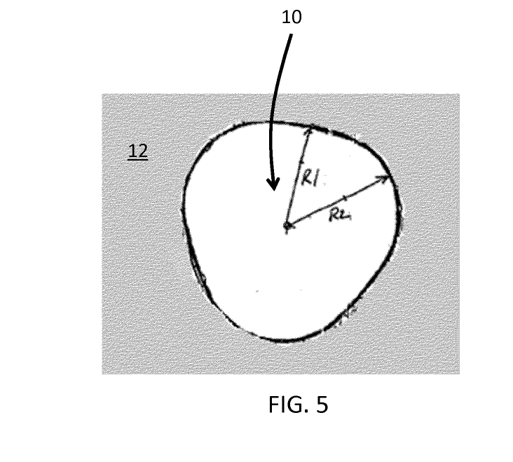

FIG. 5 depicts another embodiment of a non-round osteotomy 10 with a non-round transverse cross-sectional shape. The illustrated osteotomy 10 can be formed by drilling three holes close together where the center of each hole forms the apex of a triangle. A round implant (not shown) can be inserted into the illustrated osteotomy 10 would have result in high compressive stresses in the bone 12 in the vicinity of R1 and low compressive stresses in the bone 12 in the vicinity of R2. The formation of the osteotomy 10 can be guided by a surgical guide or a robotic surgical arm. In a modified arrangement, the non-round osteotomy 10 can be formed by using a combination of a drill and hand-held reamers that are used to enlarge portions of the osteotomy 10. In other arrangements, the osteotomy 10 can be formed by a tool that includes separate rotating end mills configured to form a non-round opening.

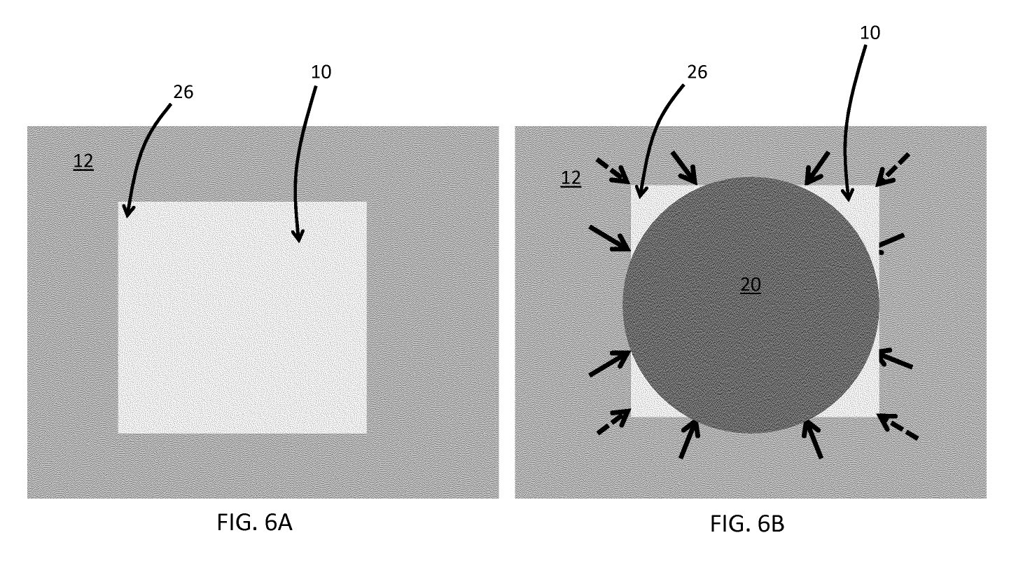

FIG. 6A depicts another embodiment of a non-round osteotomy 10 with a non-round transverse cross-sectional shape. The illustrated osteotomy 10 has a generally square shape having corner portions 26. In the illustrated embodiment, each of the four corner portions 26 forms an angle that is substantially 90°. However, is some embodiments, some of the corner portions 26 can form acute angles while other corner portions 26 form obtuse angles, giving the osteotomy 10 a rhombus or slanted rectangular shape. FIG. 6B shows a round implant 20 that has been inserted into the non-round osteotomy 10 of FIG. 6A. As shown in FIG. 6B, low compression forces (dashed arrows) can be associated with bone in the vicinity of the corner portions 26 of the osteotomy 10 while high compression forces (solid arrows) can be associated with the bone in the vicinity of the regions of the osteotomy 10 that are interposed between the corner portions 26. In certain embodiments, the implant 20 positioned within the osteotomy 10 can have a diameter that is greater than the length of one or more sides of the osteotomy 10.

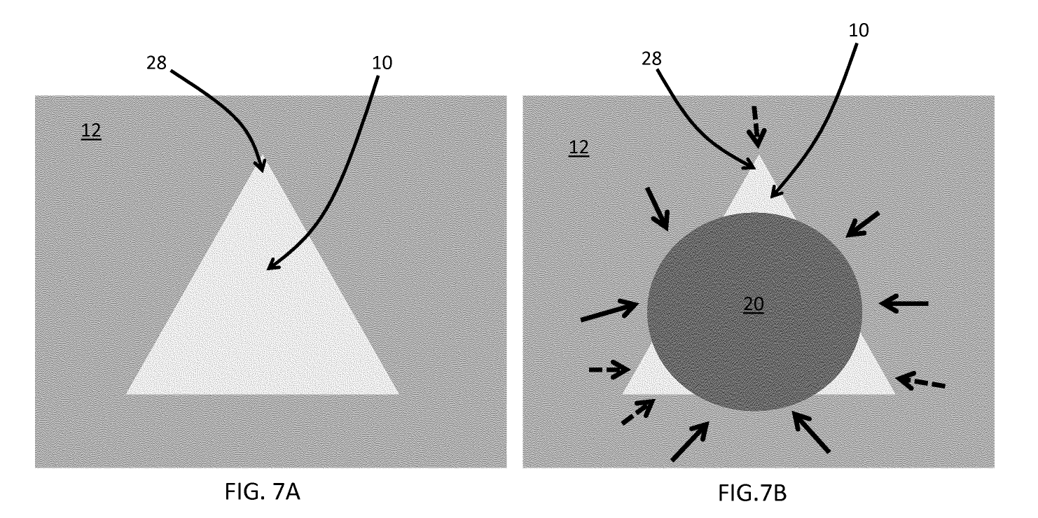

FIG. 7A depicts another embodiment of a non-round osteotomy 10 with a non-round transverse cross-sectional shape. The illustrated osteotomy 10 has a generally triangle shape having apex portions 28. In the illustrated embodiment, each of the three apex portions 28 forms an angle that is substantially 60°. In some variants, the apex portions 28 form angles that are different from one another. FIG. 7B shows a round implant 20 that has been inserted into the non-round osteotomy 10 of FIG. 7A. As shown in FIG. 7B, low compression forces (dashed arrows) can be associated with bone in the vicinity of the apex portions 28 of the osteotomy 10 while high compression forces (solid arrows) can be associated with the bone in the vicinity of the regions of the osteotomy 10 that are interposed between the apex portions 28.

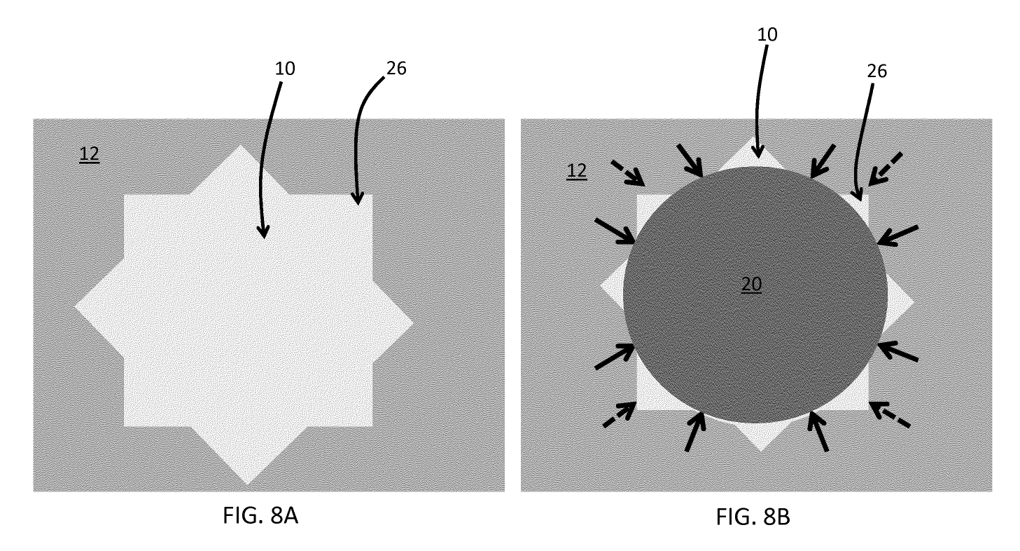

FIG. 8A depicts another embodiment of a non-round osteotomy 10 with a non-round transverse cross-sectional shape. The illustrated osteotomy 10 has a first generally square shape that is rotated substantially 45° relative to a second generally square shape. In the illustrated embodiment, the first and second generally square shapes are similar in size. In some variants, the first and second generally square shapes are different from one another in size. In certain embodiments, the first generally square shape is rotated relative to the second generally square shape at an angle other than 45° (e.g., 20°). FIG. 8B shows a round implant 20 that has been inserted into the non-round osteotomy 10 of FIG. 8A. As shown in FIG. 8B, low compression forces (dashed arrows) can be associated with bone in the vicinity of the corner portions 26 of the osteotomy 10 while high compression forces (solid arrows) can be associated with the bone in the vicinity of the regions of the osteotomy 10 that are interposed between the corner portions 26.

In certain embodiments, the non-round osteotomy 10 of the embodiments describe herein can be created with specialized tooling (e.g., special drills, lasers, piezo, millers, etc.). In certain embodiments, the non-round osteotomy 10 of the embodiments describe herein can be using a template and drilling plurality of round holes at different locations. As discussed, creating a non-round osteotomy can introduce areas of relatively lower or no stress (also referred to as “biologic zones”) and areas of relatively higher stress (also referred to as “mechanical zones”). The bone in the relatively higher stress zones can resorb and remodel the same as a round implant but the bone can remodel faster in the relatively lower stress zones. Since the rate of resorption and remodeling is different between the two zones, the implant will always be in contact with bone and therefore will not become loose or unstable. The non-round osteotomy 10 can be created with standard drills and/or a drill template. The non-round osteotomy 10 can be created with lasers and/or custom tooling. In some variants, the amount of non-roundness or misfit of the osteotomy 10 to the implant 20 in orientation is controlled at a micron level.

Certain embodiments can comprise forming osteotomy with a non-round cross-section and then inserting an implant with a non-round cross-section into the osteotomy with the non-round cross-section. To create the areas of relatively lower or no compression or stress and areas of relatively higher compression or stress, the implant can be orientated within the osteotomy such that the non-round cross-sections of the osteotomy and the dental implant are not aligned.

In the embodiments described herein, the non-round shape of osteotomy can be with respect to a cross-section that is generally perpendicular to or perpendicular to a longitudinal axis of the osteotomy, which is sometimes referred to as the “transverse cross-sectional shape” of the osteotomy herein. In a similar manner, the round or non-round shape of the implant can be with respect to a cross-section that is generally perpendicular to or perpendicular to a longitudinal axis of the implant, which is sometimes referred to as the “transverse cross-sectional shape” of the implant herein.

Certain embodiments can include a method of implanting an implant can comprise creating in a bone an osteotomy 10 having a first transverse cross-sectional shape; inserting into the osteotomy 10 an implant having a second transverse cross-sectional shape, wherein the transverse cross-sectional shape of the osteotomy is different from the transverse cross-sectional shape of the implant.

In certain embodiments, a dental implant system can comprise a device for creating in a bone an osteotomy having a first transverse cross-sectional shape; and an implant having a second transverse cross-sectional shape, wherein the second transverse cross-sectional shape is different from the first transverse cross-sectional shape.

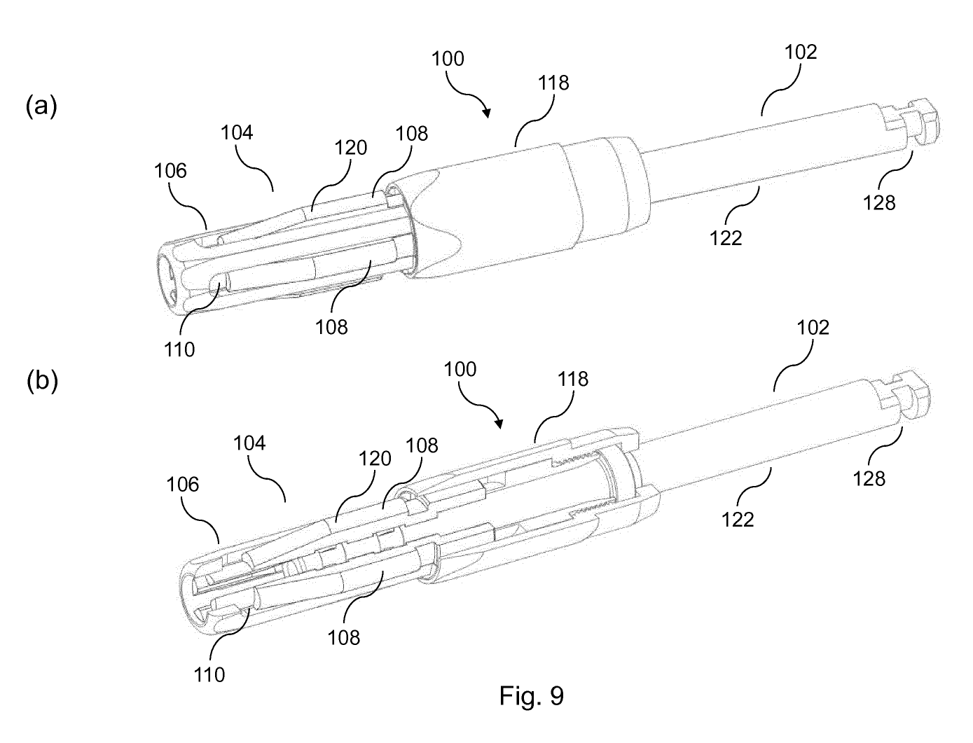

FIGS. 9 to 13 show a preparation tool 100 according to an embodiment of the present invention.

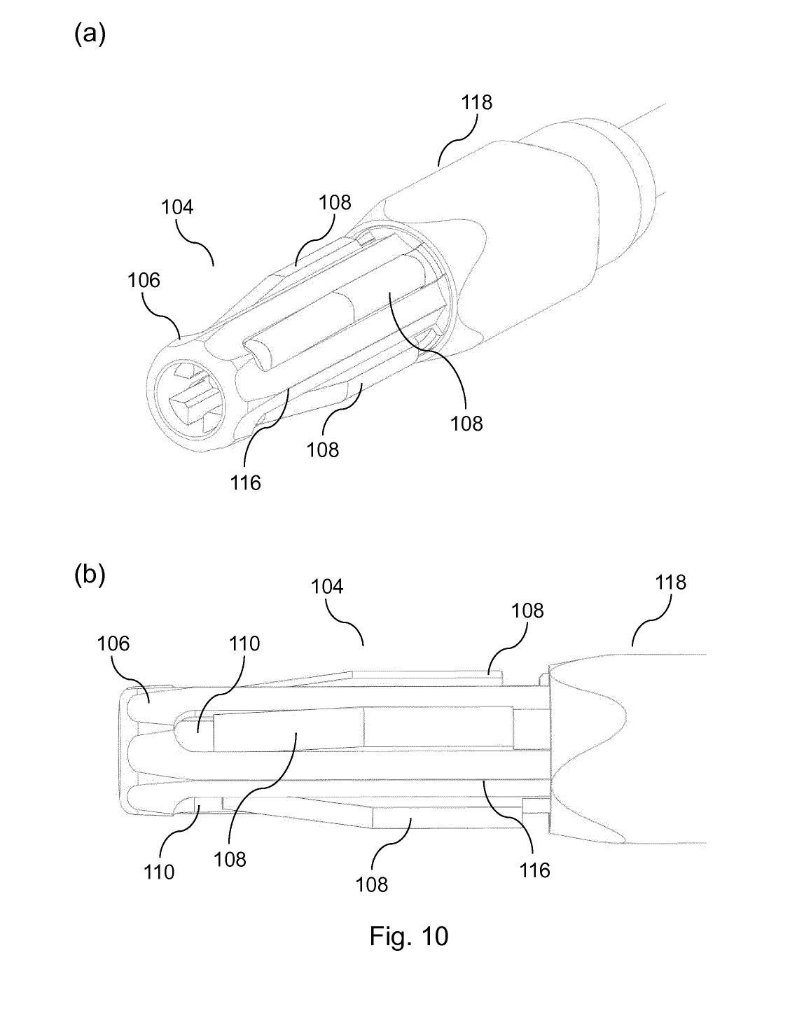

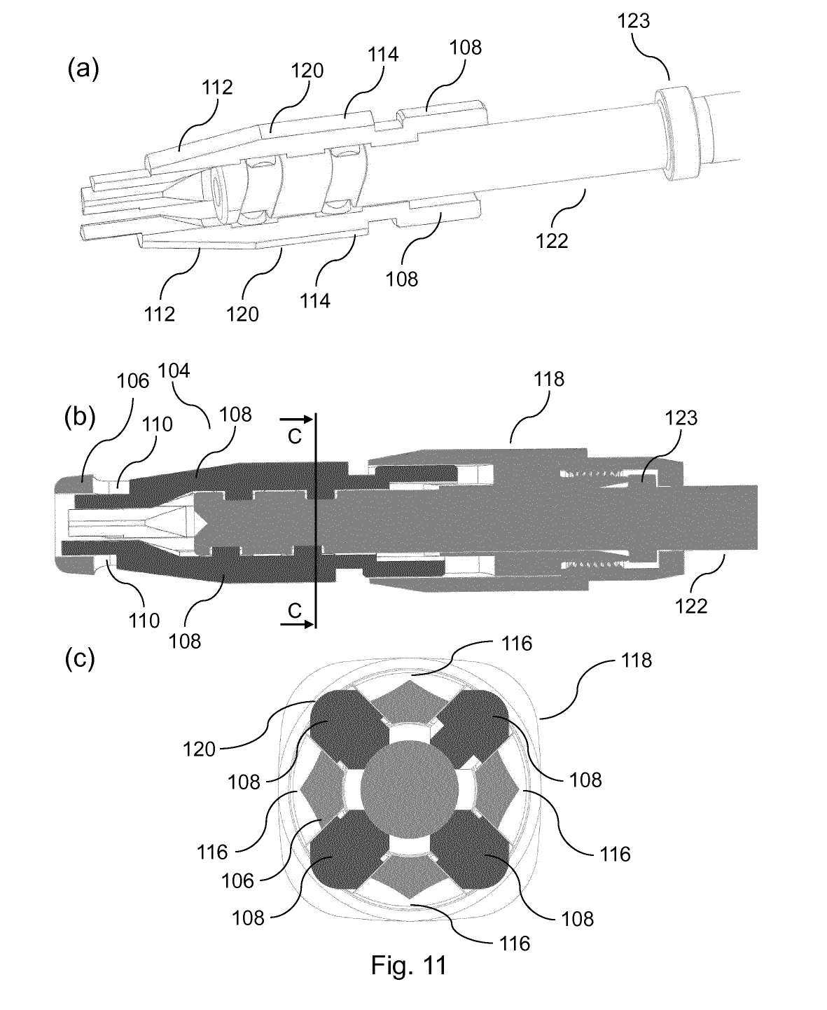

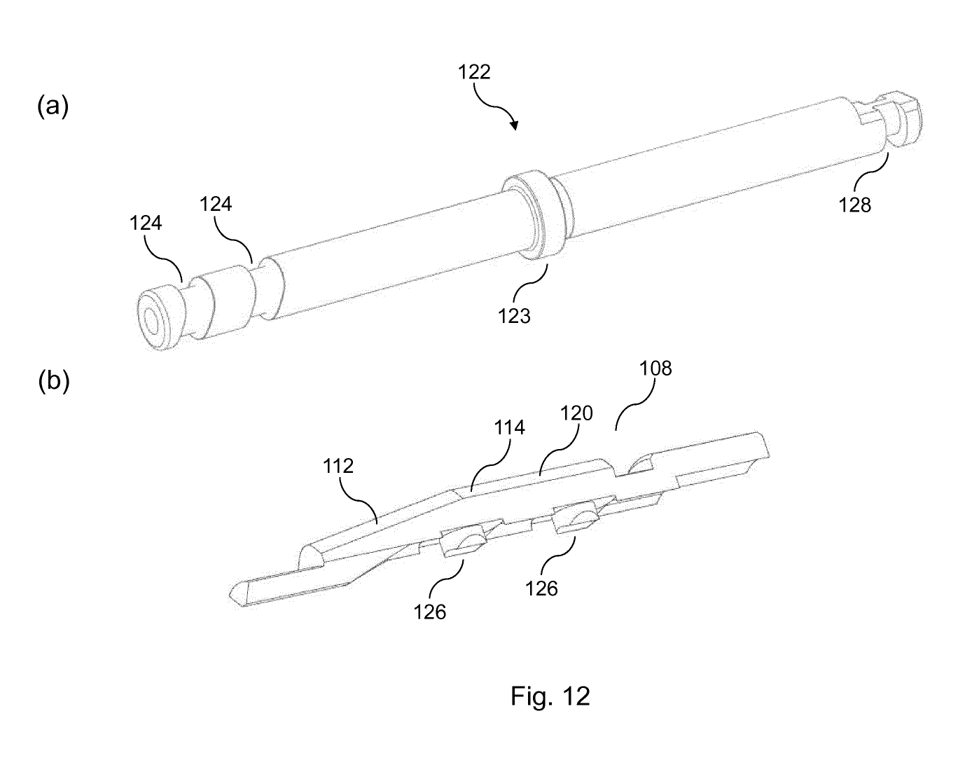

The preparation tool 100 is a preparation tool for forming a non-circular or non-round cavity, osteotomy or hole in bone tissue, such as the jaw bone of a patient. The preparation tool 100 comprises a proximal portion 102 and a distal portion 104, as is shown in FIGS. 9(a) and (b). The distal portion 104 has a main body 106 and four bone removing elements 108 (see FIG. 11(c)). A part of each bone removing element 108 extends radially outward beyond an outer circumference of the main body 106 (see, for example, FIGS. 9(a), 9(b), 10(b) and 11(b)). The four bone removing elements 108 are arranged so as to be equidistantly spaced apart from each other in the circumferential direction of the main body 106, as is shown in FIG. 11(c). Each of the four bone removing elements 108 has an elongate shape (e.g., FIG. 12(b)). The four bone removing elements 108 are movably attached to the main body 106 so that their longitudinal axes are parallel to the axial direction of the preparation tool 100. The main body 106 substantially has the shape of a hollow tube (e.g., FIGS. 10(a) and 11(b)).

Each of the four bone removing elements 108 extends, in a width direction thereof, along a portion of the outer circumference of the main body 106 in the circumferential direction of the main body 106 (see FIG. 11(c)). The width direction of each of the four bone removing elements 108 extends along a direction substantially perpendicular to the axial direction of the preparation tool 100. As is shown in FIG. 11(c), the four bone removing elements 108 are arranged so that two respective bone removing elements 108 are positioned opposite to each other.

The main body 106 and the four bone removing elements 108 may be made of the same material or of different materials.

The main body 106 may be made of, for example, a metal, such as titanium, a titanium alloy or stainless steel, a polymer, a ceramic or a composite material. The main body 106 may be manufactured, for example, by moulding, such as injection moulding, milling, such as CNC milling, etc.

Each of the four bone removing elements 108 may be made of, for example, a metal, such as titanium, a titanium alloy or stainless steel, a polymer, a ceramic or a composite material. Each of the four bone removing elements 108 may be manufactured, for example, by moulding, such as injection moulding, milling, such as CNC milling, etc.

The four bone removing elements 108 are movable relative to the main body 106 in the axial direction of the preparation tool 100. The four bone removing elements 108 are movably attached to the main body 106. Specifically, each of the four bone removing elements 108 is movably received in a corresponding channel or slit 110 formed in the main body 106, as is shown, for example, in FIGS. 9(b), 10(b) and 11(b). Each of the channels or slits 110 has an elongate shape. The channels or slits 110 are formed in the main body 106 so that their longitudinal axes are parallel to the axial direction of the preparation tool 100. Each of the four bone removing elements 108 is slidably arranged in the corresponding channel or slit 110, so as to be slidable relative to the main body 106 in the axial direction of the preparation tool 100.

The preparation tool 100 is configured so that the distal portion 104 thereof can be at least partly inserted into a pilot hole (not shown) in the bone tissue, e.g., in the jaw bone of a patient. The pilot hole may be prepared by drilling a hole in the bone tissue, e.g., following a drill protocol, as has been detailed above. The preparation tool 100 is configured to remove bone material at the inner wall of the pilot hole by means of the four bone removing elements 108, thereby forming the non-circular cavity in the bone tissue.

In order to facilitate the at least partial insertion of the distal portion 104 into the pilot hole, each of the four bone removing elements 108 has a tapered or chamfered portion 112 in which the radial extension of the respective bone removing element 108 in the directions perpendicular to the axial direction of the preparation tool 100 decreases in the direction from the proximal portion 102 towards the distal portion 104 of the preparation tool 100 (see, for example, FIGS. 11(a) and 12(b)). Further, each of the four bone removing elements 108 has a straight portion 114 which is arranged adjacent to the tapered or chamfered portion 112 in the direction from the distal portion 104 towards the proximal portion 102. In the straight portion 114, the radial extension of the respective bone removing element 108 in the directions perpendicular to the axial direction of the preparation tool 100 is constant in the direction from the proximal portion 102 towards the distal portion 104 (see, for example, FIGS. 11(a) and 12(b)).

The main body 106 has four fixation elements 116 for rotational fixation of the main body 106 in the pilot hole so as to prevent rotation of the main body 106 relative to the bone tissue in the circumferential direction of the main body 106. The four fixation elements 116 are arranged so as to be equidistantly spaced apart from each other in the circumferential direction of the main body 106, as is shown in FIG. 11(c). Each of the four fixation elements 116 is a ridge that protrudes from a remainder of the main body 106 in the radial direction of the main body 106 and extends along the axial direction of the main body 106, as is shown in FIGS. 10(a), 10(b) and 11(c). The fixation elements 116 are integrally formed with the remainder of the main body 106.

The fixation elements 116 can engage the bone tissue of the inner wall of the pilot hole, thus keeping the main body 106 substantially stationary relative to the bone tissue in the circumferential direction of the main body 106. The non-circular cavity is formed by moving the four bone removing elements 108 relative to the main body 106, while any rotational movement between main body 106 and bone tissue can be reliably avoided due to the presence of the fixation elements 116. Hence, the cavity can be formed with a particularly high degree of precision.

The preparation tool 100 further comprises an intermediate portion 118 which is arranged between the proximal portion 102 and the distal portion 104 (see, for example, FIGS. 9(a) and (b)). The intermediate portion 118 has a non-circular cross-section perpendicular to the axial direction of the preparation tool 100. Specifically, the intermediate portion 118 has a substantially square cross-section with rounded edges, as is shown in FIG. 11(c). The intermediate portion 118 is fixedly attached to the distal portion 104, in particular, the main body 106.

In addition or alternatively to the fixation elements 116, also the intermediate portion 118 of the preparation tool 100 allows for a rotation of the main body 106 relative to the bone tissue in the circumferential direction of the main body 106 to be reliably prevented when forming the non-circular cavity. In particular, the preparation tool 100 may be used together with a tool guiding means (not shown), such as a surgical template for guided surgery. The tool guiding means may have a receiving portion into which the preparation tool 100 can be at least partly inserted. This receiving portion may be configured to prevent rotation of the main body 106 of the preparation tool 100 relative to the tool guiding means and, thus, also relative to the bone tissue, by cooperation with the intermediate portion 118 which has the non-circular, i.e., substantially square, cross-section.

The bone removing elements 108 are configured to remove bone material, i.e., to take off bone material from the bone tissue, thereby forming the non-circular cavity in the bone tissue, for example, in the jaw bone of a patient. The part of each bone removing element 108 which extends radially outward beyond the outer circumference of the main body 106 is a bone removing part. The bone removing part is configured to remove bone material. The bone material may be removed, for example, by reaming bone tissue, rasping bone tissue or grinding bone tissue.

For the purpose of bone material removal, each of the bone removing elements 108, including the part thereof which extends radially outward beyond the outer circumference of the main body 106, has an abrasive surface 120 (see, for example, FIGS. 9(a), 9(b), 11(a) and 12(b)). The abrasive surface 120 is a rough surface which is configured to remove bone material, e.g., by reaming the bone tissue, rasping the bone tissue or grinding the bone tissue. Further, the abrasive surface 120 is configured to provide, in those areas or regions of the pilot hole where it comes into contact with the bone tissue and removes bone material, a rough surface of the inner wall of the cavity. The abrasive surface 120 may be a coarse abrasive surface, e.g., an abrasive surface for coarse reaming, coarse rasping or coarse grinding.

By employing the bone removing elements 108, each having the abrasive surface 120 which enables the provision of a rough surface of the inner wall of the cavity, osseointegration of the implant in the cavity can be further improved. In particular, in this way, the cells of the bone tissue can be opened, further promoting osseointegration.

As is shown, for example, in FIG. 11(c), the abrasive surface 120 is a curved surface. Specifically, the abrasive surface 120 is curved so that the radial extension of the respective bone removing element 108 in the directions perpendicular to the axial direction of the preparation tool 100 decreases from a center of the bone removing element 108 in the width direction thereof towards the edges of the bone removing element 108 in the width direction thereof (see FIG. 11(c)). By providing the abrasive surface 120 with such a curvature, the bone removal efficiency can be further enhanced.

The preparation tool 100 comprises a shaft 122 extending in the axial direction of the tool 100. The shaft 122 extends from the proximal portion 102 to the distal portion 104 of the preparation tool 100. Specifically, a proximal portion of the shaft 122 forms the proximal portion 102 of the preparation tool 100 (see, for example, FIGS. 9(a), 9(b) and 12(a)). A distal portion of the shaft 122 is received within the main body 106 (e.g., FIGS. 9(b) and 11(b)).

The shaft 122 is rotatable relative to the main body 106 and relative to the intermediate portion 118. Specifically, the shaft 122 is rotatable relative to the main body 106 and the intermediate portion 118 in a rotational direction around the axial direction of the preparation tool 100. The shaft 122 is arranged so as to be coaxial with the main body 106 and the intermediate portion 118, i.e., so that the axial direction of the shaft 122 is the same as the axial direction of the main body 106 and the intermediate portion 118. The shaft 122 is rotatable relative to the main body 106 and the intermediate portion 118 around this axial direction. The shaft 122 is also rotatable relative to the four bone removing elements 108.

The shaft 122 is held in the intermediate portion 118 in a rotatable manner by means of a connection part 123 of the shaft 122 and a corresponding bearing part of the intermediate portion 118 (see FIGS. 11(b) and 12(a)). The connection part 123 is rotatably supported by the bearing part.

The shaft 122 is connected to the four bone removing elements 108 so that rotation of the shaft 122 relative to the main body 106 causes the four bone removing elements 108 to move relative to the main body 106 in the axial direction of the preparation tool 100.

Specifically, the shaft 122 has two recesses 124 extending in the radial directions of the shaft 122 and in the circumferential direction of the shaft 122 (see FIG. 12(a)). The two recesses 124 extend along the entire circumference of the shaft 122. Further, each of the four bone removing elements 108 has two protrusions 126 extending in the radial direction of the bone removing element 108 and the radial direction of the shaft 122 (see FIGS. 11(a), 11(b) and 12(b)). Each of the two protrusions 126 is received within a corresponding one of the two recesses 124, as is shown in FIGS. 11(a) and 11(b). The two recesses 124 extend along the circumference of the shaft 122 in an undulating, wavelike or sinusoidal manner, as is indicated in FIGS. 11(a), 11(b) and 12(a).

Hence, a connection between the shaft 122 and the four bone removing elements 108 is provided which enables a reciprocating movement of the bone removing elements 108 relative to the main body 106 in the axial direction of the preparation tool 100 upon continuous rotation of the shaft 122 relative to the main body 106. In particular, the recesses 124 and the protrusions 126 are arranged so that continuous rotation of the shaft 122 relative to the main body 106 causes the four bone removing elements 108 to reciprocate relative to the main body 106 in the axial direction of the preparation tool 100, wherein the movements of the bone removing elements 108 relative to the main body 106 are out of phase with each other. In this way, a balance between the forces acting on different parts of the bone tissue when forming the non-circular cavity can be achieved in an efficient manner.

The shaft 122 can be rotated relative to the main body 106, e.g., by driving the shaft 122 by hand or with a motor (not shown), such as a rotation motor, so as to cause the bone removing elements 108 to move relative to the main body 106 in the axial direction of the preparation tool 100. For this purpose, the shaft 122 of the preparation tool 100 of the present embodiment has, at its proximal end, a coupling part 128 which allows for the shaft 122 to be coupled to a motor (see, for example, FIGS. 9(a), 9(b) and 12(a)).

The reciprocating movement of the bone removing elements 108 relative to the main body 106 in the axial direction of the preparation tool 100 allows for the non-circular cavity to be formed in a particularly simple and reliable manner. Further, this reciprocating movement can be effected in a simple way, by continuously rotating the shaft 122 relative to the main body 106, e.g., manually or by using a rotation motor or the like.

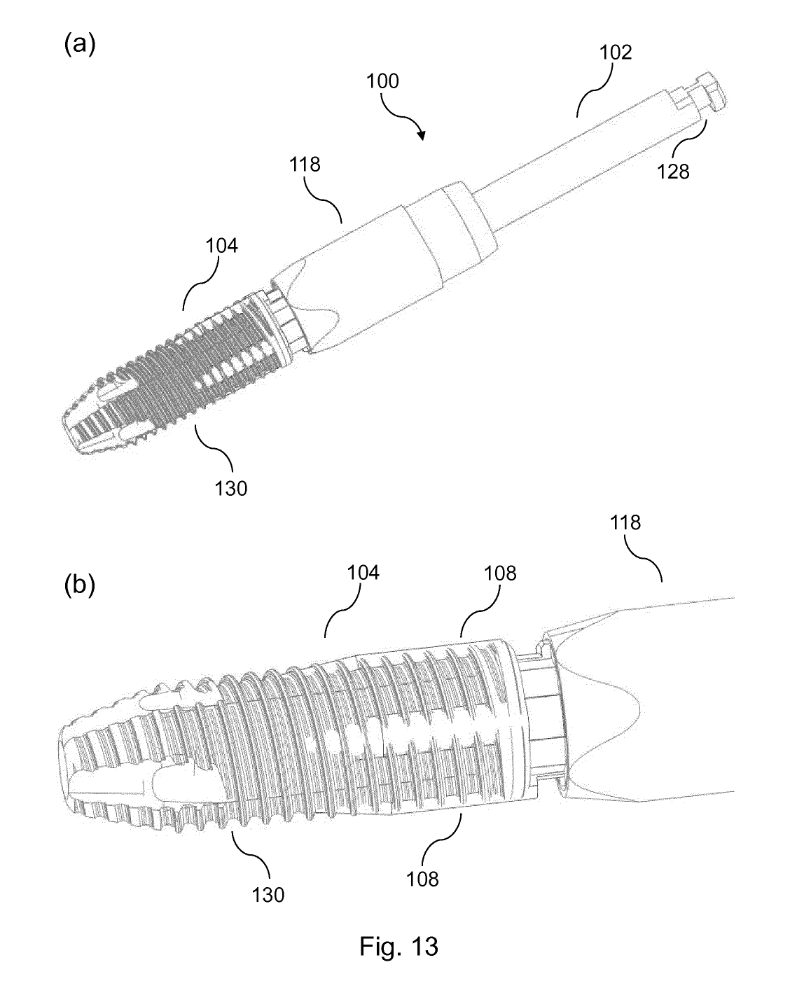

FIGS. 13(a) and (b) show perspective overlay views of the preparation tool 100 and an implant 130, which is a threaded dental implant, in order to illustrate the relative dimensions of the implant 130 and the preparation tool 100, in particular, the distal portion 104 thereof. The preparation tool 100 and the implant 130 together form a kit according to an embodiment of the present invention.

The implant 130 has a circular cross-section perpendicular to the axial direction of the implant 130. By using the preparation tool 100 together with the implant 130 having a circular cross-section, i.e., by forming a non-circular cavity in bone tissue by means of the tool 100 and inserting the implant 130 therein, a particularly high degree of stability and improved osseointegration of the implant 130 can be ensured, as has been detailed above.

The distal portion 104 of the preparation tool 100 has a radial extension in some directions perpendicular to the axial direction of the preparation tool 100 which is larger than a radial extension of the implant 130 in the directions perpendicular to the axial direction of the implant 130 and a radial extension in other directions perpendicular to the axial direction of the preparation tool 100 which is smaller than the radial extension of the implant 130 in the directions perpendicular to the axial direction of the implant 130. Specifically, as is shown in the illustrative overlay views of FIGS. 13(a) and (b), parts of the bone removing elements 108 of the distal portion 104 have larger radial extensions than the implant 130.

In this way, it can be ensured that both “biologic zones” and “mechanical zones” are introduced when inserting the implant 130 into the non-circular cavity prepared by the preparation tool 100. Since the rate of bone resorption and remodelling is different for these two types of zones, the implant 130 will always be in contact with the bone tissue and, therefore, not become loose or unstable. Hence, a particularly high degree of stability and good osseointegration of the implant 130 can be ensured.

It should be emphasized that many variations and modifications may be made to the herein-described embodiments, the elements of which are to be understood as being among other acceptable examples. All such modifications and variations are intended to be included herein within the scope of this disclosure and protected by the following claims. Moreover, any of the steps described herein can be performed simultaneously or in an order different from the steps as ordered herein. Moreover, as should be apparent, the features and attributes of the specific embodiments disclosed herein may be combined in different ways to form additional embodiments, all of which fall within the scope of the present disclosure.

1. A preparation tool (100) for forming a non-circular cavity in bone tissue, the preparation tool comprising
a proximal portion; and
a distal portion, wherein
the distal portion has a main body and at least one bone removing element, and
at least a part of the at least one bone removing element extends radially outward beyond an outer circumference of the main body.

2. The preparation tool according to claim 1, wherein the at least a part of the at least one bone removing element has an abrasive surface.

3. The preparation tool according to claim 1, wherein the at least one bone removing element is movable relative to the main body in the axial direction of the preparation tool.

4. The preparation tool according to claim 3, further comprising a shaft extending in the axial direction of the preparation tool, wherein
the shaft is rotatable relative to the main body, and
the shaft is connected to the at least one bone removing element so that rotation of the shaft relative to the main body causes the at least one bone removing element to move relative to the main body in the axial direction of the preparation tool.

5. The preparation tool according to claim 4, wherein the shaft is connected to the at least one bone removing element so that continuous rotation of the shaft relative to the main body causes the at least one bone removing element to reciprocate relative to the main body in the axial direction of the preparation tool.

6. The preparation tool according to claim 4, wherein
the shaft has at least one recess extending in the radial direction of the shaft and in the circumferential direction of the shaft,
the at least one bone removing element has at least one protrusion extending in the radial direction of the shaft, and
the at least one protrusion is at least partly received within the at least one recess, or wherein
the shaft has at least one protrusion extending in the radial direction of the shaft and in the circumferential direction of the shaft,
the at least one bone removing element has at least one recess extending in the radial direction of the shaft, and
the at least one protrusion is at least partly received within the at least one recess.

7. The preparation tool according to claim 4, wherein the shaft extends from the proximal portion to the distal portion.

8. The preparation tool according to claim 4, wherein a proximal end of the shaft is exposed to the outside of the preparation tool.

9. The preparation tool according to claim 1, wherein the main body has at least one fixation element for rotational fixation of the main body in a pilot hole formed in bone tissue so as to prevent rotation of the main body relative to the bone tissue in the circumferential direction of the main body.

10. The preparation tool according to claim 1, further comprising an intermediate portion, wherein
the intermediate portion is arranged between the proximal portion and the distal portion, and
at least a part of the intermediate portion has a non-circular cross-section perpendicular to the axial direction of the preparation tool.

11. (canceled)

12. The preparation tool according to claim 1, wherein a distal part of the at least one bone removing element has a radial extension in one or more directions perpendicular to the axial direction of the preparation tool, which radial extension decreases in the direction from the proximal portion towards the distal portion.

13. The preparation tool according to claim 1, wherein the distal portion has a plurality of bone removing elements.

14. The preparation tool according to claim 13, wherein the bone removing elements are arranged so as to be spaced apart from each other in the circumferential direction of the main body.

15. The preparation tool according to claim 14, wherein the bone removing elements are arranged so as to be equidistantly spaced apart from each other in the circumferential direction of the main body.

16. (canceled)

17. (canceled)

18. (canceled)

19. (canceled)

20. (canceled)

21. (canceled)

22. (canceled)

23. A method of forming one or more zones of no or lower bone stress and one or more zones of higher bone stress around a dental implant comprising,
forming a hole in a patient's bone, the hole forming a first transverse cross-sectional shape; and
inserting a dental implant into the hole, the dental implant having a portion positioned within the hole that has a second transverse cross-sectional shape that is different than the first transverse cross-sectional shape such that when the portion of the dental implant is inserted into the hole one or more zones of no or lower bone stress and one more zones of higher bone stress are created around the portion of the dental implant.

24. The method of claim 23, wherein the first transverse cross-sectional shape is non-round and the second transverse cross-sectional shape is round.

25. The method according to claim 23, wherein the hole in the patient is formed by drilling more than one hole in the patient with each hole having a different center axis.

26. The method according to claim 25, further comprising using a template to form the more than one hole in the patient.

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. An assembly comprising an implant and a tool for creating an osteotomy with a non-round transverse cross-section.

42. The assembly of claim 41, wherein the implant is a dental implant.

43. The assembly of claim 41 wherein the non-round osteotomy has a generally oval transverse cross-sectional shape, a generally square transverse cross-sectional shape, and/or a generally triangular transverse cross-sectional shape

44. The assembly of claim 41 wherein the tool for creating a non-round osteotomy comprises one or more of custom tooling, lasers, piezo surgical instrumentation, standard drills, and/or drill templates.

45. (canceled)

46. (canceled)

47. (canceled)
